(19) United States
(12) Patent Application Publication
(10) Pub. No.: US 2012/0259679 A1
(43) Pub. Date: Oct. 11, 2012

(54) METHOD AND SYSTEM FOR DEVISING AND TRACKING MEASURES FOR ORGANIZATIONAL VALUE CREATION

(75) Inventor: Matthew Frank Barney, Mysore (IN)

(73) Assignee: INFOSYS TECHNOLOGIES LIMITED, Bangalore (IN)

(21) Appl. No.: 13/314,456

(22) Filed: Dec. 8, 2011

(30) Foreign Application Priority Data
Apr. 7, 2011 (IN) 1185/CHE/2011

(51) Int. Cl. G06Q 10/06

(52) U.S. Cl. 705/7.37

(57) ABSTRACT

A method and a system disclosed for determining measures being taken across an organization based on the performance specifications of a cross-level value-chain. The method includes designing the value-chain. The value-chain defines various strategic business goals, such as customer goals, financial goals, and differentiator goals of the organization. Once the value-chain is designed, outcome, input, and moderating parameters are identified to realize the strategic business goals. Thereafter, the performance of the value-chain designed to realize the strategic business goals is simulated. The performance of the value-chain is simulated in one or more scenarios to output uncertainties in achieving the strategic business goals. Thereafter, the probability of achieving the strategic business goals is determined. Subsequently, one or more measures to be taken in the organization are generated based on the have been method described above.

This application claims the benefit of Indian Patent Application Filing No. 1185/CHE/2011, filed Apr. 7, 2011, which is hereby incorporated by reference in its entirety.

### FIELD OF THE INVENTION

The present invention relates, in general, to executing business strategy across various levels of an organization. More specifically, the present invention relates to a method and a system for determining measures to be taken in an organization based on the performance of a value-chain.

### BACKGROUND

Every organization has a vision of the future, and a mission. A mission statement defines the fundamental purpose of an organization, and a vision statement describes the future aspirations. Goals are the plan of actions that are defined across an organization to achieve the mission and vision statement. Goals should be defined in a way that is achievable by the organization. There is typically more than one goal to be achieved in order to achieve the end-state defined in the vision.

To achieve such goals successfully, the organization needs to formulate and execute a business strategy, through its' processes known as a “value chain”. A value-chain for any business is a set of processes/activities that when combined, realize the objectives of the business. For instance, the value-chain includes activities relating to marketing characteristics, distribution channels, advertising, sales, operations, finance and related projects and programs. To begin, leaders of an organization formulate a business—an approach that if executed, will secure competitive advantage in the marketplace. Once the strategy is formulated, the strategy must be implemented effectively to achieve the goals. To implement, the strategy must be deconstructed to mitigate the risk of the presence of bottlenecks, in spite of uncertainty. A common obstacle to an organization's successful implementation of the strategy is the inability of leaders to translate the strategy to action efficiently, particularly across large organizations that span geographies, time zones, product lines, and industries. At present, there is no platform available which enables the organization leaders to formulate and then execute a business strategy to specify their value-chain across levels of analysis, geographies, time zones, product lines and/or industries. With the existing systems and methods, strategy execution is a time-consuming and defect-laden process involving a complex analysis of the organization and its environment. Thus, unavailability of a platform to design an effective strategy and execute it, is laborious and ineffective.

A number of methods and systems for realizing business objectives exist in the prior art. However, there is no complete framework that enhances the capability leaders to formulate/design and subsequently execute the business strategy. Further, a number of solutions are available in the market to evaluate the effectiveness of operational actions across an organization. But these solutions fail to evaluate the investments prospective and actual efficacy across levels of analysis in the organization. Moreover, these existing solutions are not capable of identifying various bottleneck areas in the business strategies. In addition to the above, these existing methods and systems fail to formulate and implement the business strategies for large organization. This is because complexity of the business strategies increases with an increase in the number of employees, Lines of Businesses (LOBs), and geographies.

Consequently, there is a need for a method and a system facilitating such a framework that enhances the capability of leaders to design/formulate a value-chain. Further, there lies a need for determining or evaluating the performance of the value-chain across various levels in the organization. This ensures that the performance of the value-chain is realized in all distributed parts of the organization and all bottleneck areas get highlighted.

### SUMMARY

The present invention describes a system for determining one or more measures being taken across an organization based on performance specifications of a cross-level value-chain designed to realize strategic business goals. In particular, the present invention describes a system for determining one or more sub-goals, operationally defined into measures that specify target values required to realize strategic business goals. The system includes a user interface configured for designing the goals and projects required at each level and stage of a value-chain. Various examples of the ultimate, strategic business goals may include, but are not limited to, customer goals, financial goals, and market goals. Lower level, goals that enable the core value-chain are specified holistically with Quality, Cost, Quantity and Cycle-Time targets that are both necessary and sufficient to realize ultimate strategic goals. The system described above includes a controller, wherein the controller includes a goal setting module, a simulation module, and an optimization module. The goal setting module is configured for identifying outcome, input, and moderating parameters to realize the strategic business goals. Further, the simulation module is configured for simulating the performance of the value-chain that is designed to realize the strategic business goals. The performance of the process is simulated in one or more scenarios to ensure a high likelihood of achieving the strategic business goals in spite of a uncertainties. The optimization module determines the probability of achieving the strategic business goals. This determination estimates the performance of the value-chain, and it highlights one or more bottleneck areas that either threaten or prevent goal attainment without remediation. The optimization module includes a database that captures the leadership team's decisions about the actions (e.g. projects) that must be taken to realize each set of targets in each segment of the value-chain, creating a form of strategy execution knowledge retention. In addition, the system described above includes a report engine. The report engine is configured for generating a graphical view of one or more measures and projects or actions deployed to drive the metric to the targeted levels. The report engine works in collaboration with the controller to compute measures, statistics that compare measures with targets, and the requisite actions that are intended to be necessary and sufficient to realize the target(s).

The present invention describes a method for determining one or more measures being taken across an organization based on performance specifications of a cross-level value-chain designed to realize strategic business goals. More specifically, the present invention provides a method for determining one or more measures and targeted metric levels that are required across an organization to realize strategic business goals. The method includes designing the value-chain, wherein the value-chain defines strategic business goals of the organization. Examples of the strategic business goals may include, but are not limited to, customer goals, financial goals, and market goals. Once the core process is designed, the outcome, input, and moderating parameters are identified to realize the strategic business goals. After identifying the outcome, input, and moderating parameters, the performance of the value-chain designed to realize the strategic business goals is simulated. The performance of the value-chain is simulated in one or more scenarios to output uncertainties in achieving the strategic business goals. In addition to the above, the invention includes the use of various simulation methods including but not limited to Monte Carlo, Discrete Event, Petri, Colored Petri and Markov Chain methods designed to estimate the likely performance of the value chain in the presence of risk and uncertainty.

After simulating the performance of the process, the probability of achieving the strategic business goals is determined. The determination outputs the likely performance distributions contrasted with the targeted levels specified by the firm-level strategy. A key output is the identification of one or more bottleneck areas, where monitoring or additional actions may be required to realize the ultimate firm-level goals. Once the probability of achieving the strategic business goals is determined, one or more actions (e.g. projects, job tasks, decisions) are made, and inputted into the system for ensuring that investments payoff to the full level desired by the value-chain targeted specifications. Further, the system uses the relational database structure between measured targets (e.g. Defect Density) and improvement actions (e.g. Lean Six Sigma improvement projects) as a knowledge management archive for future use by other seeking similar improvement actions, thereby increasing the probability of remedy replication in the future.

Additionally, the present invention describes a Computer Program Product (CPP) for determining one or more performance specifications being taken across an organization. The CPP includes a program instructions means for designing the value-chain and consequent strategic business goals of the organization. Examples of the strategic business goals of the organization may include customer goals, financial goals, and market goals. Further, the CPP includes a program instructions means for identifying outcome, input, and moderating parameters that affect the realization of strategic business goals. The CPP further includes a program instructions means for simulating the performance of the value-chain designed to realize the strategic business goals in one or more scenarios to output uncertainties in achieving the strategic business goals. Furthermore, the CPP includes program instructions means for determining the probability of achieving the strategic business goals. The resultant report indicates the probability of performance in the value chain. In addition, the determination further highlights one or more bottleneck areas of the process. In addition to the above, the CPP includes a program instruction means for generating the one or more measures that the system will track, in real time, for further strategy deployment in the organization.

### BRIEF DESCRIPTION OF THE DRAWINGS

Various embodiments of the invention will hereinafter be described in conjunction with the appended drawings provided to illustrate, and not to limit, the invention, wherein like designations denote like elements, and in which:

FIG. 1 illustrates an environment in which various embodiments of the invention may be practiced, in accordance with an embodiment of the invention; and

FIG. 2 is a flow diagram for determining one or more measures being taken across an organization based on the performance specifications of a cross-level value-chain, in accordance with an embodiment of the invention.

### DETAILED DESCRIPTION OF THE INVENTION

The present invention relates to strategy evaluation, where the performance of a business strategy is evaluated. As strategy can neither be formulated nor modified to changing conditions without a process of strategy evaluation and execution, the strategy evaluation forms an essential step of strategic management process. It helps an organization in determining efficiency and effectiveness of the comprehensive strategic plans in achieving the desired goals. In the strategy evaluation process, leaders determine whether the chosen business strategy is achieving the organization's goals successfully. Accordingly, one or more measures must be established and tracked to ensure that the operation realize ultimate strategic objectives. Examples of various measures of the organization may include, but are not limited to, financial measures, customer measures, and skill levels. The myriad investments required to achieve the ultimate objectives in the end, include physical asset investments, information technology investments, human resource investments, and various remediation actions that produce new operational knowledge for effectiveness that is necessary and sufficient to execute the strategy. This likelihood is the ultimate evaluation of any strategy to determine—is it working, and is the firm winning.

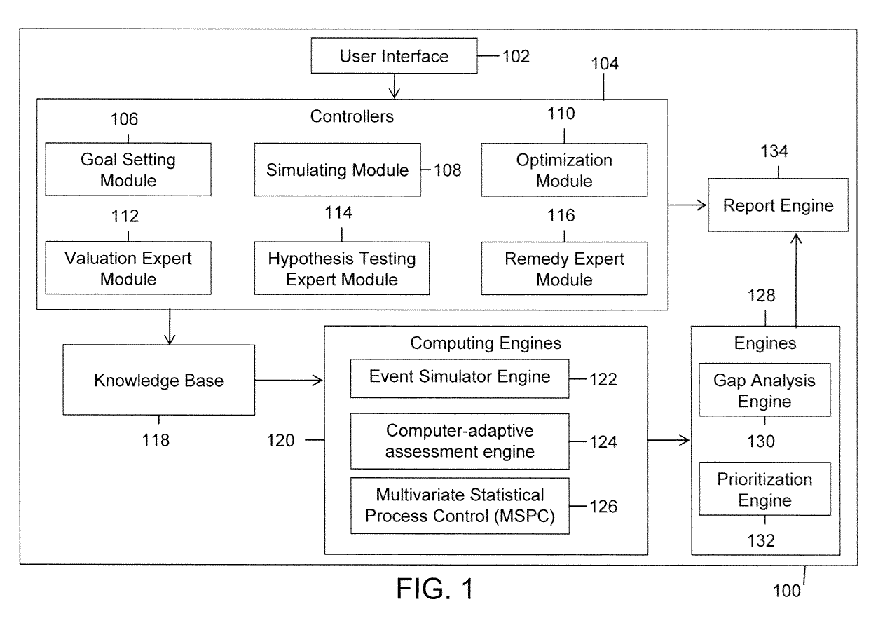

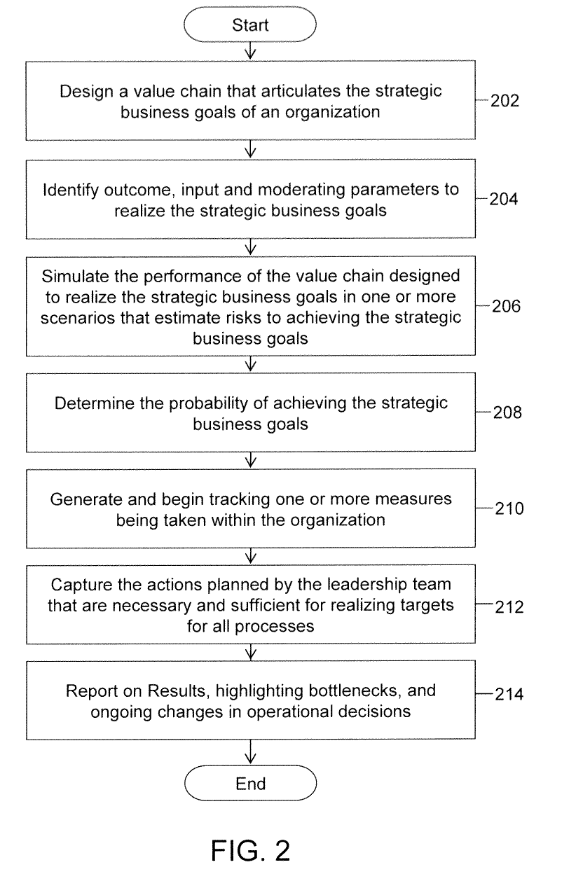

FIG. 1 illustrates an environment in which various embodiments of the invention may be practiced. To describe the system elements illustrated in FIG. 1, references will be made to FIG. 2. It will be apparent to those skilled in the art that the steps executed by the system elements can be applicable to any other embodiment of the present invention.

As depicted in FIG. 1, system 100 includes a user interface 102, controllers 104, a knowledge base 118, computing engines 120, engines 128, and a report engine 134. Controllers 104 include a goal setting module 106, a simulating module 108, an optimization module 110, a valuation expert module 112, a hypothesis testing expert module 114, and a remedy expert module 116. Further, computing engines 120 includes an event simulator engine 122, a computer-adaptive assessment engine 124, and a Multivariate Statistical Process Control (MSPC) 126. Engines 128 include a gap analysis engine 130 and a prioritization engine 132.

In accordance with various embodiments of the present invention, various system elements as depicted in FIG. 1 are described herein. Event simulator engine 122 leverages one or more simulation methodologies (e.g. discrete event, Monte Carlo, Petri) to estimate the probability of realizing the business objectives as a result of the process design and planned leadership investments. Further, it produces estimates that the leadership team can evaluate as to whether the level of certainty is within the risk tolerance of the firm. In case the level of certainty is not within the risk, then appropriate changes are made until the a priori (pre-deployment) hypothesis that the strategy will not be executed as rejected with sufficient certainty.

MSPC engine 126 is designed to identify the detection of variation, and ‘out of control’ processes easier, especially across complex, geographically distributed, and diverse offering lines in matrixed and hierarchical organizations. Further, the present invention specifies the necessary and sufficient conditions for process performance across all four Cue See model factors (QCQC). Accordingly, MSPC engine 126 calculates the degree to which the processes are in control and likely to realize goals, or conversely out of control, and containing special cause variation that may be remediated. The current embodiment includes all the major quantitative techniques known to quantify the multivariate SPC statistics that can determine automatically whether a set of processes is in control or not. Once determined that the various processes are in control, MSPC engine 126 determines the degree to which the process capability is at or below the minimum requirements. It calculates various process capability statistics known to those familiar with industrial engineering (e.g. the statistics known in the prior art as CpK, CpM, and variants). By working in tandem with prioritization engine 126, MSPC engine 126 sorts the various process capability measures for each stakeholder, such that they can see the largest gap (least capable process) that is in scope for their area of responsibility. For example, senior leaders are able to get a report of the weakest process capabilities in the firm, and the degree to which they threaten firm-level goal attainment. However, a leader who oversees marketing, in contrast, would only see, by default, the weakest sub-processes in the marketing area for him or her to work on unless senior leaders have specified otherwise (e.g. downstream production is the key strategic constraint and not sales/marketing).

Hypothesis testing expert module 114 is used to evaluate, posteriori, whether or not specific process targets were realized within the timeframe desired by the original strategy. If less than significant, hypothesis testing expert module 114 can flag the key bottleneck areas and recommend specific actions to be taken. The specific actions are determined, based on historical success from the actions database of similar actions targeted on either the same metric or process area, or on similar related problems. In this way, hypothesis testing expert module 114 helps senior leaders to verify that the strategy is being deployed effectively. If not, then context-relevant actions are provided that may be required to realize the same goal.

Prioritization engine 132 evaluates alternative configurations of decisions from either event simulator engine 122 or hypothesis testing module 114 to determine the degree to which the combined portfolio of decisions is likely to payoff. It includes a module for leadership Real Options, known to those skilled in the Finance profession, along with a variety of decision optimization routines (i.e. linear and non-linear programming, binomial lattices, and genetic algorithms). The output of prioritization engine 132 suggests which bundles of investments are highest priority, and should be tried first or next—such that as uncertainty resolves itself, lower priority choices may be made later.

Computer-adaptive assessment engine 124 leverages either Rasch Measurement or Item Response Theory parameters to deploy appropriate human measurements for a plurality of purposes including customer satisfaction assessment, pre-employment testing, skill certification/verification, team effectiveness, organizational culture & climate, and organizational citizenship behavior. The most important dimensions to the leadership team's ability to realize goals are included in the test engine that is systematically connected to performance feedback. It provides a GUI for nomination of stakeholders (in the multisource, or 360 survey embodiment), a computer-adaptive assessment deployment module, and one or more reports that are situated in the context of the value chain metrics. The deployment module administers a medium difficulty item first, and adapts subsequent items until a leadership-defined termination criterion is met. The termination criterion may include, but is not limited to a, minimum standard error threshold achieved, or minimum attribute level realized. The preferred embodiment utilizes the Quality, Cost, Quantity, and Cycle-Time (QCQC) measures along with organizational citizenship behaviors that include helping behavior in a team, extra-role work tasks, to reward and recognize employee performance.

User interface 102 enables a user of an organization to formulate/design a detailed business strategy in terms of a value-chain. The business strategy is defined while keeping in mind the organizations' mission statement. The user of an organization may be an organizational leader, senior executive, and the like. The value-chain includes one or more sub-processes (or activities) which define various strategic business goals of an organization. These goals are defined by the top management of the organization, such as Chairman, and Chief Executive Officer (CEO), Executive Vice Presidents, and Senior Vice Presidents. Examples of various strategic business goals may include, but are not limited to, customer goals, differentiator goals, market goals, performance goals, and financial goals. A value-chain is an integrated set of activities organized in a business to achieve the specified strategic business goals. Further, the value-chain and its sub-processes may vary with the type of business/industry. For example, the value-chain strategic business for a service-based industry may include activities, such as customer service, marketing and sales, accounting and finance, systems support, legal support, organization environment, human resources, and new services. In another example, the value-chain for a product based industry may include activities, such as material purchase, manufacturing, inventory management, shipping and logistics, customer service, marketing and sales, accounting and finance, systems support, legal aspects, organization environment, human resources, and new products.

The strategic business goals of the organization as described above are further defined/distributed across various levels/units of the organization. In an example, it can be assumed that one of the strategic business goals of an organization, such as a software organization, is to achieve revenue of a hundred million dollars per year. Accordingly, each of the units of the software organization, such as analysis and designing unit, coding unit, implementation unit, testing unit, and maintenance unit need to achieve a portion of that target based on their employees strength and area of expertise. To achieve this goal of the organization, each of these units may need to work in collaboration with each other to reach to their ultimate organization-level goals. For any organization to function properly, it needs employees in the form of team members, general managers, managers, leaders, senior leaders, sales executives, etc., with mastered skills or specialization. Accordingly, an organization must determine how to bundle these employees and their capabilities to form core competencies and then use these competencies to satisfy customer needs by implementing the value-chain.

After designing the value-chain, goal setting module 106 identifies various parameters, such as outcome, input, and moderating parameters. Input parameters may correspond to the factors of production that will perform the work tasks in the value-chain. Further, the input parameters to the value chain may include minimum QCQC requirements for suppliers, information technologies, outsourcing partners (Service Level Agreements), and employee attributes. Moderating parameters correspond to the factors that may affect the ability of the assets to produce the value designed in the process. They are typically not in the control of the leadership team such as competitor actions, governmental regulations, and weather (i.e. Cyclones). In one embodiment of the invention, the outcome, input, and moderating parameters are input by the user using user interface 102. In another embodiment of the invention, the outcome, input, and moderating parameters are automatically identified by goal setting module 106 based on the information stored in knowledge base 118. Examples of the process parameters may include, but are not limited to, Quality, Cost, Quantity, and Cycle-Time (QCQC). Further, these identified parameters are used to realize the strategic business goals across various levels of the organization. These strategic business goals are realized by using one or more techniques, for example, event simulating techniques, computer-adaptive assessment techniques, multivariate statistical processing techniques, or one or more combinations of these techniques.

Once the strategic business goals are realized, simulating module 108 simulates the performance of the value-chain in one or more scenarios to output uncertainties in achieving the strategic business goals. The one or more scenarios may include, but are not limited to, customer satisfaction and customer acquisition. An output of simulation module 108 may be pessimistic, optimistic, or viable. For example, if the output is pessimistic, achieving the strategic business goals could be challenging. However, if the output is optimistic, there is an opportunity of achieving the strategic business goals. And if the output is viable, the strategic business goals are absolutely achievable. The simulation may be performed by using various event simulation techniques, such as simulating using the Monte Carlo method.

After outputting the uncertainties, valuation expert module 112 analyzes the uncertainties in detail and accordingly provides appropriate suggestions to leaders of the organization. The suggestions are provided after extracting information from knowledge base 118. Thereafter, optimization module 110 determines the probability of achieving the strategic business goals. This determination outputs the performance of the value-chain, and it highlights bottleneck areas of each level of the value-chain. For example, optimization module 110 highlights bottleneck areas in marketing and sales, accounting and finance, organization environment, and the like. Optimization module 110 determines this probability by using techniques such as computer-adaptive assessment techniques, multivariate statistical processing techniques, or one or more combinations of these techniques. Once the probability of achieving the strategic business goals is determined, remedy expert module 116 tracks one or more actions to be taken in the organization. Examples of the actions may include, but are not limited to, training programs for a team, devising new policies, and replacing key individuals.

Thereafter, gap analysis engine 130, as depicted in FIG. 1, determines gaps between the established strategic business goals and the actual business goals. The actual business goals correspond to the goals that are achieved post implementing the value-chain. The gaps are determined by using statistical analysis based on the probability of achieving the strategic business goals. This helps in providing the organization with insights into areas which could be improved. In an example, it can be assumed that the strategic business goal of an organization may be a customer delight. The customer delight is calculated based on parameters, but are not limited to, quality, organization-customer relationships, and delivery timelines. Based on the methodology described above, it may be determined that the probability of achieving the goals is 60%. Further, using the statistical analysis, gap analysis engine 130 determines a 40% lag in achieving the business goals. Accordingly, gap analysis engine 130 identifies that the parameter such as timelines and organization-customer relationships need to be improved.

Subsequently, report engine 134 generates one or more measures to be taken in the organization based on its interaction with controllers 104.

As depicted in FIG. 1, knowledge base 118 stores information relating the value-chain, the strategic business goals, the outcome, input, and moderating parameters, the actions and historically remediation strategies. Computing engines, such as event simulator engine 122, computer-adaptive assessment engine 124, and MSPC engine 126 implement various algorithms to output results. For the one ordinary skilled in the art, it is apparent that the processes described above are well known in the art.

Moreover, system 100 includes an encryption module (not shown in figure) providing security controls in the organization. The encryption module defines various access levels for using system 100 based on person's level or role in the organization. Further, encryption module implements various security routines to ensure data is kept confidential and is viewable by only those users who have been granted access to a certain level. For example, a senior leader, such as a CEO or Chairman, may be allowed to view/modify all levels of the value-chain. However, a junior management employee of the organization may only be able to view details corresponding to their department and fill in the required details. Such users may not be allowed to view complete details and modify the value-chain.

FIG. 2 is a flow diagram for determining one or more measures being taken across an organization based on the performance specifications of a cross-level value-chain, in accordance with an embodiment of the invention. To describe the method illustrated in FIG. 2, references will be made to FIG. 1. It will be apparent to those skilled in the art that the method can be applicable to any other embodiment of the present invention.

At 202, a value-chain is designed by a senior leader of an organization. The value-chain articulates the strategic business goals of an organization. An organization can have various levels/divisions. In an example, various divisions of a software organization may include designing and coding unit, testing unit, and maintenance unit. In another example, various divisions of a service based organization may include business research unit, investment research unit, sales unit and the like. Further, at each of the divisions, the corresponding stakeholders are identified who will be assigned responsibilities to provide details on goal status.

A value-chain is a chain of one or more activities (or sub-processes), where a product or a service passes through these activities for gaining value at each stage. The value-chain is a combination of primary activities and secondary activities. The primary activities are majorly involved in creating and delivering the product/service. However, the secondary activities are not directly involved in the production/delivering the service, but may enhance the efficiency or effectiveness of the process.

The value-chain and the associated activities are specific to the type of business/industry. For example, retailers focus on activities, such as inbound and outbound logistics and procurement, while many manufacturing companies focus on activities, such as operations and technology development. In another example, software companies focus on activities such as marketing and sales; however, banks focus on activities such as services and firm infrastructure.

In an exemplary embodiment of the present invention, the value-chain for a product based industry is defined. Here, the primary activities of the value-chain may include inbound logistics, operations, outbound logistics, marketing and sales, and services. Further, the secondary activities may include procurement, technology development, human resource management, and organization infrastructure.

In another exemplary embodiment of the invention, the value-chain for a service based industry is described. The primary activities of the value-chain may include marketing and sales, and service. And, the secondary activities may include technology development, human resource management, and organization infrastructure.

The value-chain defines various strategic business goals across various levels of the organization. These goals are established by executive management, such as stakeholders. These stakeholders are responsible for each of the activities of the value-chain. Examples of the strategic business goals may include, but are not limited to, customer goals, competitor goals, performance goals, and differentiator goals. As an example, goal of the activities of the value-chain may include, offering a service to a customer exceeding the cost of activities of the value-chain resulting profit-margin.

In accordance with an embodiment of the present invention, the value-chain is designed by using a user interface, such as user interface 102. The user interface enhances the capability of a leader to design the value-chain. Hence, a lot of time and effort required by the leader is reduced.

After designing the value-chain, at 204, outcome, input, and moderating parameters are identified to realize the strategic business goals. These outcome parameters can be used to quantify successful performance required for achieving the strategic business goals. Various examples of the outcome parameters as described below may include, but are not limited to, Quality, Cost, Quantity, and Cycle-Time (QCQC). The input parameters correspond to QCQC when realized on data, such as terms and conditions. Also, the moderating parameters correspond to QCQC when realized in the middle of the sub-processes of the value-chain, such as marketing and sales, and firm infrastructure and have described above in detail. Further, these parameters are cascaded to each of the sub-processes of the value-chain. This ensures that the performance of each of the sub-processes of the value-chain is tracked.

Quality parameter focuses on quality requirements that should be met with respect to the standard process of an organization. Also, defect density must have a low value. Additionally, any additional objective of the customer that delights them can also be considered as a quality requirement.

Cost parameter describes that cost which is necessary for the attainment of the goal must be invested from the customer side. For example, over and under expenditure from the customer's side must be avoided. Accordingly, focus should be on having sufficient budget with high probability of achieving quality, quantity, and cycle-time goals.

Quantity parameter describes volume requirements that must be met to delight customer. For example, providing insignificant capacity or marginal capacity should be avoided. Accordingly, focus should be on providing sufficient capacity to fulfill customer requirements in the time frame as they desire.

Cycle-Time parameter describes time frame requirements that must be met to delight customer. For example, if results are delivered too late, it may be undesirable for the customer. Accordingly, results should be delivered in accordance within the time frame as mentioned by the customer.

Each of these outcome parameters as described above is associated with targets. For example, the target associated with each of these parameters may be, high-quality, sufficient cost, sufficient volume, and delivery on time as defined by the customer. Further, the identified outcome, input, and moderating parameters are used for realizing the strategic business goals. Once the strategic business goals are realized, one or more actions to be taken in the organization are tracked. Examples of the actions may include, but are not limited to, training programs for a team, devising new policies, replacing key individuals, and hiring staff. These actions and the associated details are stored in a knowledge base, such as knowledge base 118. Thereafter, remediation actions of the one or more actions that are identified as successful in removing a bottleneck area based on historical information are recommended. These remediation actions are identified based on the information stored in the knowledge base. The knowledge base stores information for all possible bottlenecks/problems along with their remedial actions (solutions) taken in the past. And for each of the bottlenecks, there might be more than one proposed solutions along with their eventual outcomes/success rate. Accordingly, solutions that were identified as successful in eliminating the bottlenecks can be recommended to deal with the present bottleneck areas.

An exemplary depiction of the knowledge base storing various details in the tabular format has been shown below, combined with standard hyperlink technology known in the art to access archives of project information:

| | | Bottleneck | | Outcome |
|---|---|---|---|---|
| Years | Goals | Area(s) | Actions | (Successful) |
| 2006 | Performance- | Organization | Devising new | Y |
| | based goals | environment | policies/developing | |
| | | | new performance | |
| | | | incentive | |
| 2007 | Customer- | Marketing | Hiring new sales | N |
| | based goals | and sales | executives/replacing | |
| | | | one or more key | |
| | | | individuals | |
| 2008 | Customer- | Legal | Developing training | Y |
| | based goals | support | programs | |
| 2009 | Profitability- | Systems | Developing | Y |
| | based goals | support | organization | |
| | | | infrastructure | |
| 2010 | Differentiator- | Customer | Needs to be | — |
| | based goals | service | determined | |

The remediation actions that are adequate for the designed process to realize the targets of the outcome, input, and moderating parameters are verified. The verification is performed to ensure that the actions being taken are sufficient to understand the targets of the outcome, input, and moderating parameters.

Then, at 206, the performance of the value-chain designed to realize the strategic business process is simulated. The performance is simulated in one or more scenarios to output uncertainties in achieving the strategic business goals. The scenarios may include, but are not limited to, customer goals.

After simulating the performance of the value-chain, at 208, the probability of achieving the strategic business goals is determined. The determination outputs the performance of the value-chain across various levels of the organization. Then at 210, tracking one or more measures being taken within the organization are generated and tracked. Subsequently, at 212, actions planned by the leadership team that are necessary and sufficient for realizing targets for all processes are captured. The actions are captured and maintained in knowledge base 118. Lastly, at 214, report on results, highlighting bottlenecks, and ongoing changes in operational decisions is generated. This reduces the complexity involved in decision making for a leader.

In accordance with an embodiment of the present invention, gaps between the established strategic business goals and the actual business goals are determined. The gaps are determined by using statistical analysis based on the probability of achieving the strategic business goals. This helps in providing the organization with insights into areas which could be improved. Subsequently, the one or more measures to be taken in the organization are generated. The one or more measures as generated may include corrective measures or corrective actions. Examples of the measures may include altering organization's structure, revising a business mission, revising strategic business goals, replacing one or more key individuals, devising new policies, developing new performance incentive, adding additional sales-persons, and change in the value-chain.

In addition to the above, the method facilitates tracking actions that are taken across the organization. These actions are designed to make improvements in the outcome parameters (QCQC). This helps in accounting bottlenecks of the value-chain. The method also provides suggestion to the leader about projects that have been successful in the past in relieving the bottleneck in another process or part of the organization. Further, the method focuses on providing stochastic decision support to model the portfolio of actions. And the leader hypothesis may be required to fully eliminate the bottleneck by including probabilistic portfolio management and valuation analysis. The method further facilitates automatically tracking the efficacy of decisions in improving the bottleneck targets. Furthermore, the methodology described above acts as the backbone for performance management of subordinates by making transparent objectively measured QCQC targets. Moreover, the method also focuses on enhancing team coordination by providing an automatic multisource assessment of team coordination. This ensures that individual and team behavior are adapted well to execute bottlenecks with effective collaboration.

For an embodiment of the present invention, the value-chain, the outcome, input, and moderating parameters, the actions, historically remediation strategies and the like are stored in the knowledge base.

In accordance with an embodiment of the present invention, the steps as described above are computed using techniques such as event simulation techniques, computer-adaptive assessment techniques, Multivariate Statistical Process Control (MSPC) techniques, or one or more combinations of these techniques.

The method and the system described above have numerous advantages. The present invention facilitates a user interface which enhances the capability of a leader to design a value-chain. Thus, a lot of effort and time required by the leader is saved. Further, the present invention facilitates an approach for determining the performance of the value-chain across various levels in the organization. This ensures that the performance of the value-chain is realized in all distributed parts of the organization. Moreover, the present invention helps in tracking performance at each level of the value-chain. Additionally, the present invention focuses on identifying bottleneck areas of the value-chain.

The method and the system for determining one or more measures being taken across an organization based on performance specifications of a cross-level value-chain designed to realize strategic business goals, or any of its components, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks such as the steps that constitute the method for the present invention. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions (program instruction means) can be embedded in a computer program product for use with a computer, the computer program product comprising a computer usable medium with a computer readable program code embodied therein. Processing of input data by the processing machine may be in response to users' commands, results of previous processing, or a request made by another processing machine.

The modules described herein may include processors and program instructions that are used to implement the functions of the modules described herein. Some or all the functions can be implemented by a state machine that has no stored program instructions, or in one or more Application-specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. A system for determining one or more measures being taken across an organization based on performance specifications of a cross-level value-chain designed to realize strategic business goals, the system comprising:
a. a user interface configured for designing the value-chain, the value-chain defining the strategic business goals of the organization;
b. a controller comprising:
i. a goal setting module configured for identifying outcome, input and moderating parameters to realize the strategic business goals;
ii. a simulation module configured for simulating the performance of the value-chain designed to realize the strategic business goals in one or more scenarios to output uncertainties in achieving the strategic business goals;
iii. an optimization module configured for determining the probability of achieving the strategic business goals, wherein the determination outputs the performance of the value-chain, the determination highlighting one or more bottleneck areas of the value-chain; and
c. a report engine configured for generating the one or more measures being taken in the organization based on the interaction of the report engine with the controller.

2. The system according to claim 1 further comprising a remedy expert module configured for:
a. identifying actions being taken after realizing the strategic business goals;
b. recommending remediation actions being identified as successful in remediating a bottleneck area based on historical information; and
c. verifying the remediation actions being necessary and sufficient for the designed process to realize outcome parameters targets.

3. The system according to claim 1 further comprising a gap analysis engine configured for determining gaps between the established strategic business goals and actual business goals.

4. The system according to claim 1 further comprising an event simulator engine configured for interacting with the controller.

5. The system according to claim 1 further comprising a computer-adaptive assessment engine configured for interacting with the controller.

6. The system according to claim 1 further comprising a Multivariate Statistical Process Control (MSPC) engine configured for interacting with the controller.

7. The system according to claim 1 further comprising a knowledge base configured for storing information relating to the value-chain, the strategic business goals, the outcome parameters, actions, and historically effective remediation strategies.

8. The system according to claim 1 further comprising an encryption module configured for providing security controls across the organization.

9. The system according to claim 1, wherein the value-chain comprises one or more sub-processes.

10. The system according to claim 1, wherein the strategic business goals include customer goals, financial goals, market goals and differentiator goals.

11. The system according to claim 1, wherein the outcome parameters include Quality, Cost, Quantity, and Cycle-Time (QCQC).

12. The system according to claim 1, wherein the goal setting module is further configured for cascading the outcome parameters to one or more sub-processes of the value-chain.

13. A method for determining one or more measures being taken across an organization based on performance specifications of a cross-level value-chain designed to realize strategic business goals, the method comprising:
a. designing the value-chain, the value-chain defining the strategic business goals of the organization;
b. identifying outcome, input and moderating parameters to realize the strategic business goals;
c. simulating the performance of the value-chain designed to realize the strategic business goals in one or more scenarios to output uncertainties in achieving the strategic business goals;
d. determining the probability of achieving the strategic business goals, wherein the determination outputs the performance of the value-chain, the determination highlighting one or more bottleneck areas of the value-chain; and
e. generating the one or more measures being taken within the organization based on (b), (c), and (d).

14. The method according to claim 13 further comprising:
a. identifying actions being taken after realizing the strategic business goals; and
b. recommending remediation actions being identified as successful in remediating a bottleneck area based on historical information; and
c. verifying the remediation actions being necessary and sufficient for the designed process to realize outcome parameters targets.

15. The method according to claim 13 further comprising determining gaps between the established strategic business goals and actual business goals.

16. The method according to claim 13 further comprising storing information relating to the value-chain, the strategic business goals, the outcome parameters, actions, and historically effective remediation strategies.

17. The method according to claim 13 further comprising providing security controls across the organization.

18. The method according to claim 13 further comprising cascading the outcome parameters to one or more sub-processes of the value-chain.

19. The method according to claim 13, wherein the value-chain comprises one or more sub-processes.

20. The method according to claim 13, wherein the strategic business goals include customer goals, financial goals, market goals and differentiator goals.

21. The method according to claim 13, wherein the outcome parameters include Quality, Cost, Quantity, and Cycle-Time (QCQC).

22. A computer program product for use with a computer, the computer program product comprising a computer usable medium having a computer readable program code embodied therein for determining one or more measures being taken across an organization based on performance specifications of a cross-level value-chain designed to realize strategic business goals, the computer readable program code comprising:
a. a program instructions means for designing the value-chain, the value-chain defining the strategic business goals of the organization;
b. a program instructions means for identifying outcome, input and moderating parameters to realize the strategic business goals;
c. a program instructions means for simulating the performance of the value-chain designed to realize the strategic business goals in one or more scenarios to output uncertainties in achieving the strategic business goals;
d. a program instructions means for determining the probability of achieving the strategic business goals, wherein the determination outputs the performance of the value-chain, the determination highlighting one or more bottleneck areas of the value-chain; and
e. a program instruction means for generating the one or more measures being taken in the organization based on (b), (c), and (d).

23. The computer program product according to claim 22, wherein the value-chain comprises one or more sub-processes.

24. The computer program product according to claim 22, wherein the strategic business goals include customer goals, financial goals, market goals and differentiator goals.

25. The computer program product according to claim 22, wherein the outcome parameters include Quality, Cost, Quantity, and Cycle-Time (QCQC).
